(19) United States
(12) Patent Application Publication
(10) Pub. No.: US 2025/0091666 A1
(43) Pub. Date: Mar. 20, 2025

(54) AERODYNAMIC APPARATUS FOR SERIES 1 FREIGHT CONTAINERS

(71) Applicant: Trevor Pan, Tempe, AZ (US)

(72) Inventor: Trevor Pan, Tempe, AZ (US)

(21) Appl. No.: 18/424,798

(22) PCT Filed: Jul. 29, 2022
(86) PCT No.: PCT/US2022/038959

§ 371 Date: Jan. 29, 2024

Related U.S. Application Data
(60) Provisional application No. 63/226,965, filed on Jul. 29, 2021.

(51) Int. Cl. B62D 35/00

(52) U.S. Cl. CPC B62D 35/001

(57) ABSTRACT

A magnetic, pliable membrane (68) is applied to the sides of a prior art series 1 freight container (10) where structural steel flutes (54) are exposed. The membrane smooths out gaps formed by steel flutes (54) for improved aerodynamic performance when a semi-truck carrying a series 1 freight container (10) is in transit.

### TECHNICAL FIELD

My present disclosure is directed to standard ISO intermodal freight containers, train cars, and other cargo containers where aerodynamic improvements that reduce wind drag on the mode of transit are desired.

### BACKGROUND ART

### Series 1 Freight Containers:

Malcom McClean revolutionized global trade when he introduced the shipping container. The innovation was not immediately adopted, but in 1968, twelve years after he introduced the container, an international standard was finally agreed upon. It was known as an ISO 668-series 1 freight container.

### Containers in Detail:

The cargo container itself has not seen much inventive interest from those in the shipping industry since Malcom McClean revolutionized shipping with the Ideal-X inaugural container shipment (Apr. 26, 1956) and then later standardized the industry (Sep. 24, 1965).

Since then, interest around the cargo container has lied substantially on the capacity of ships and port-side cranes, not on fuel savings.

The intermodal cargo container is ubiquitous, handy, and extremely useful. It is singularly responsible for globalization.

One must marvel at the utility of a container through its spare use of material. The sidewalls and roof are made of a fluted steel deck. Its fluted shape achieves great strength with a minimal thickness of corten steel.

This does not translate to a reduction in wind drag, however.

### PRIOR ART DESCRIBED

### Containers:

US 2009/0230725 uses an applied, dimpled surface to reduce wind drag on an already smooth tractor trailer. The patent was not granted.

U.S. Pat. No. 10,745,066 adds radiused walls to an existing smooth tractor trailer. The added structure alters the shape of the trailer to improve aerodynamics. It does not anticipate working with cargo containers or the constraints of being tightly packed on a cargo ship.

50 U.S. Pat. No. 4,756,256 was designed to work with rail cars on a multi-unit railway car. Essentially, the apparatus smoothed out the gaps between the cars, reducing wind drag. This patent did not anticipate intermodal use.

In US 2010/0116932 fairing panels on a cargo aircraft envelope one or more cargo containers. The patent was not granted.

Similar to the '256 patent, U.S. Pat. No. 4,518,188 provides a side panel to prevent air turbulence from occurring between the tractor and the trailer. This does not apply to an intermodal cargo container.

U.S. Pat. No. 8,496,286 creates a rib-like protruding post for sidewall panels on a tractor trailer. It does not concern an intermodal cargo container.

WO 2021-124175 is a reflective film intended to emit and/or reduce heat passively from a building or vehicle. It primarily intends to mold or form to a shape. It does not intend to smooth out a shape-such as the deep flutes on a modular, intermodal cargo container.

US 2011/0181072 created separate wings intended to fly over the top of a vehicle, trailer or cargo box. While the patent was not granted, its attempt was admirable; wings for “reducing the effective weight,” presumably, would lift the cargo trailer off the ground leaving the truck down below but still attached at the hitch.

It would be a hazard to all who neared the traveling apparatus.

U.S. Pat. No. 3,372,503 is a flat, rigid magnetic sign attached to a protruding strip structure behind the planar surface. The strip structure provides openings on the tailwind side of the sign to create a low-pressure condition aimed at preventing the sign from being sucked away from the trailer during transit. It is intended to attach to a metallic “flat” truck trailer wall, not a fluted metallic surface such as a cargo container.

https://www.insofast.com/products/40-ft-shipping-container-insulation-9-ft-high-cube-sidewall-cx44-bundle.html is an insulation meant to smooth out the flutes of a cargo container for the purposes of creating a living area. This product does not contemplate intermodal cargo transport.

https://www.slideshare.net/BrandonHilliard6/an-aerodynamic-study-of-bulk-commodity-tractor-trailers contemplates providing a protruding “nose-cone” at the upper portion of the front of a tractor trailer, such that the space above the rear wheels of the truck is filled with a shape to deflect wind and reduce wind drag. It is not contemplated for use on an intermodal cargo container.

### SUMMARY

### Technical Problem

Series 1 freight containers are efficient apparatus for conveying freight.

They were not designed to be aerodynamic.

The structural flutes used to form the walls of the series 1 freight container provide a substantial amount of drag when pulled by a tractor trailer.
According to testing by Lawrence Livermore National Laboratory, containers with corrugated sides have a significantly higher aerodynamic drag that makes for a rather large fuel economy deficit. I was recently in a Department of Energy meeting where they reported about a 10% fuel economy loss when comparing these types of containers to a smooth sided 53 ft. dry van. (Fleetowner.com, 2015)

The Executive Director of the North American Council for Freight Efficiency rightly observed the issue; yet, from my own personal research, as well as my patentability search firm, the industry did not provide a fix in the past seven years.

How did this not attract entrepreneurial and inventive attention over the past 66 years?

I believe that it has not attracted such attention because of the brutal nature of how series 1 freight containers are treated. They are lifted, banged, dropped, and bumped about ports, ships, trucks, and trains. They need to be tough.

While steel flutes are remarkably strong and efficient, they do not improve fuel efficiency.

It would be interesting to know how many billion gallons of diesel have been wasted since 1968 driving with the exposed flutes. With the national price of diesel at $5.735 USD per gallon, I imagine logistics companies would be eager to save if they could (AAA, 2022).

With the 2021 United Nations Climate Change Conference (COP26) having recently ended, and nation pledges made, carbon emission reduction is all the more important.

### Solution to Problem

I can apply a pliable membrane over the flutes of series 1 freight containers. Applying a membrane that withstands 120 km per hour, or 75 mph, is challenging as the flutes do not provide a continuous surface to adhere to. This is why several vertical rows of magnet anchors are required, as not all flutes will be perfectly aligned. Several vertical rows enable the pliable membrane to work on series 1 freight containers built from different manufacturers without customizing each and every pliable membrane.

To be absolutely sure the drag reduction would be valuable to trucking driving professionals, I commissioned a computational fluid dynamics (CFD) study by Auto Research Center located in Indiana, USA.

The following is an exact printout of the report:
BidBird was interested in understanding the possible fuel economy improvements by installing smooth panels onto a 40-foot container trailer.
   Baseline Case-2016 International Prostar, 73″ Sleeper Sky-Rise Cab
   CFD conducted in accordance with GHG2 & California Air Resources Board protocols
Overall Drag
CdA=6.663
Cd=0.625
Simulations carried out at wind 65 mph with +4.5 degrees of yaw. The wind is coming from the driver's left side. This is customary as it simulates a realistic scenario for over the road trucking as most often there is some cross wind and these parameters have shown to correlate well to real world conditions.
Overall Drag
CdA=6.026
Cd=0.565

For a large blunt object, much of the drag comes from the pressure difference between the front and the back faces. Regions facing the wind tend to be high pressure, shown in red, and cause drag. The picture below shows how each of the flutes on the container adds to the drag (Cp>0 in yellow).

(Unfortunately, I did not submit these color images due to PCT Rule 11.13. But they are available upon request.)

The skinned container shows much less drag generated on the side

(Unfortunately, I did not submit these color images due to PCT Rule 11.13. But they are available upon request.)

The below picture shows the iso-surfaces of total pressure equal to zero. These iso-surfaces show large wake structures that are generated around the truck. These are areas of large energy losses and contribute to drag. The structure seen behind the truck causes a large portion of the drag. This is normal for semi-trucks; however, what can also be seen is that each flute also has areas of energy loss.

(Unfortunately, I did not submit these color images due to PCT Rule 11.13. But they are available upon request.)

Below is a comparison of the two wake structures.

(Unfortunately, I did not submit these color images due to PCT Rule 11.13. But they are available upon request.)

Since it is difficult to clearly see the difference, the picture below shows the skinned container with its wake structure in light blue overlaid with the standard container in green. We can see that the structure behind the standard container is longer thus causing more drag.

(Unfortunately, I did not submit these color images due to PCT Rule 11.13. But they are available upon request.)

CFD gives us the ability to separate the drag contributions of each part of the tractor trailer combination. Although many times the interaction between parts makes it difficult to see where the drag reductions are generated, in this case we can clearly see the skinned container trailer contributes much less drag to the overall system.

| | Overall Drag | Container Only |
|---|---|---|
| Drag Baseline | 0.625 | 0.139 |
| Skinned Container | 0.565 | 0.072 |
| Delta | 0.0600 | .067% |
| Change | 9.6% | 48.4% |
| estimated fuel savings | 5.2% | |

### Advantages

As Auto Research Center proved, estimated fuel savings of 5.2% is a handsome improvement.

In addition to a pliable membrane that may be applied to existing containers, I also propose that newly constructed series 1 freight containers receive an outer, durable panel proud of the steel flutes. Such panels could be a thin layer of corten sheet steel, welded in place. Plastic panels would also work. Basically, anything that bridges the gaps of the steel flutes and is rigid.

The embodiments are not limited to series 1 freight containers, when viewing a train drive by in Tucson, Arizona, I have seen thousands upon thousands of freight cars with protruding structure.

I further propose skinning those apparatus.

### BRIEF DESCRIPTION OF DRAWINGS

FIG. 1A low aerial orthogonal view of a prior art series 1 freight container

FIG. 2A below eye-level perspective view of a prior art series 1 freight container where joists can be seen below 235 FIG. 3A table of the CFD results

FIG. 4A table of the CFD results

FIG. 5A view of a pliable membrane and how to arrange magnet anchors according to FIGS. 3 and 4

FIG. 6 An upper perspective view of a magnet anchor formed from a piece of pliable membrane which is heat welded

FIG. 7A lower perspective view of magnet anchor formed from a piece of pliable membrane which is heat welded

FIG. 8A plan view of how magnet anchors adhere to a steel flute

FIG. 9A perspective view of a pliable membrane with wind seal attached

FIG. 10A low aerial perspective view of a skinned series 1 freight container

### Embodiments

FIG. 11A top plan view of magnet anchor punched from a steel plate

FIG. 12A bottom plan view of magnet anchor punched from a steel plate

FIG. 13 An elevation view of magnet anchor punched from a steel plate

FIG. 14A perspective view of a magnet anchor punched from a steel plate

FIG. 15A plan view of a pliable membrane with integrally formed protruding volumes of pliable membrane material which are sized, shaped and placed to make contact with the valley of a steel flute

### BEST MODE FOR CARRYING OUT THE INVENTION

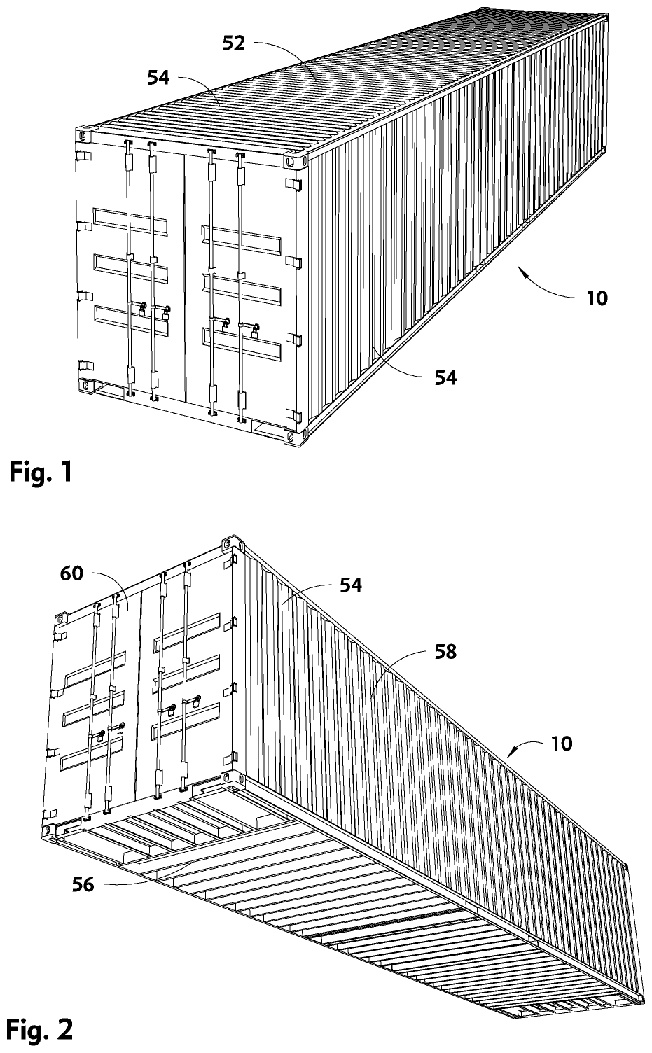

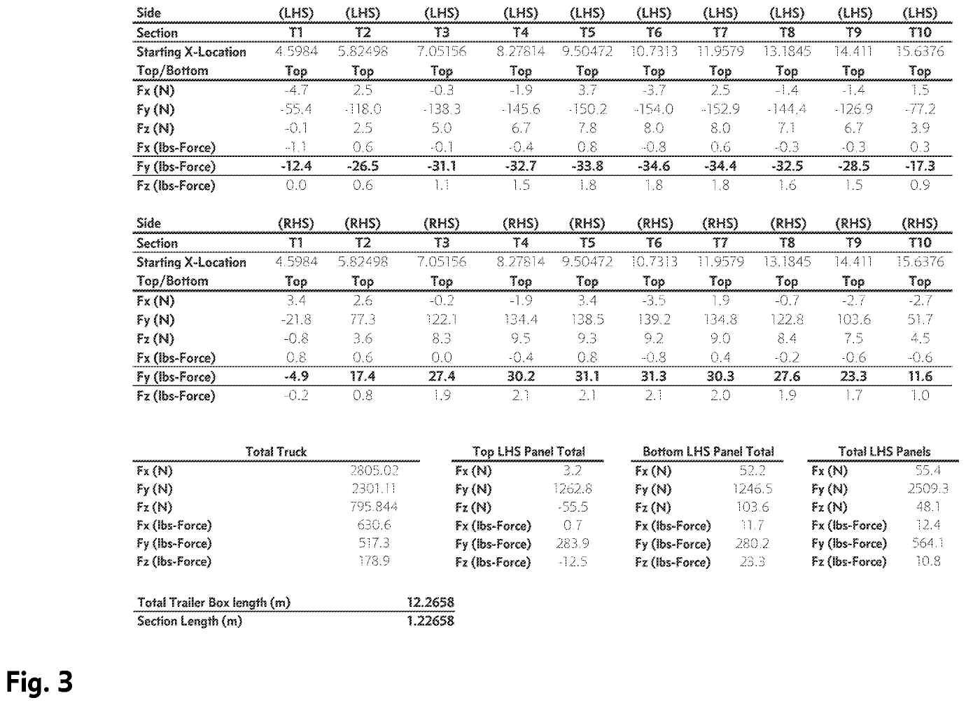

FIG. 1 shows a low-aerial perspective view of a prior art series 1 freight container 10. It is apparent from the flutes 54 on the container side wall 58 that the surface is rough and prone to aerodynamic drag.

Also shown are the flutes 54 on the top side 52 of a series 1 freight container 10.

FIG. 2 shows an underside perspective view of a prior art series 1 freight container 10 largely similar to FIG. 1. Bottom framing 56 on the underside of the container is also prone to aerodynamic drag.

While it is possible to use a pliable membrane for the underside of the series 1 freight container 10, it seems more reasonable to use a rigid panel, such as sheet steel. The panel could be screwed or welded.

FIG. 3 shows a table of the CFD results from Auto Research Center.

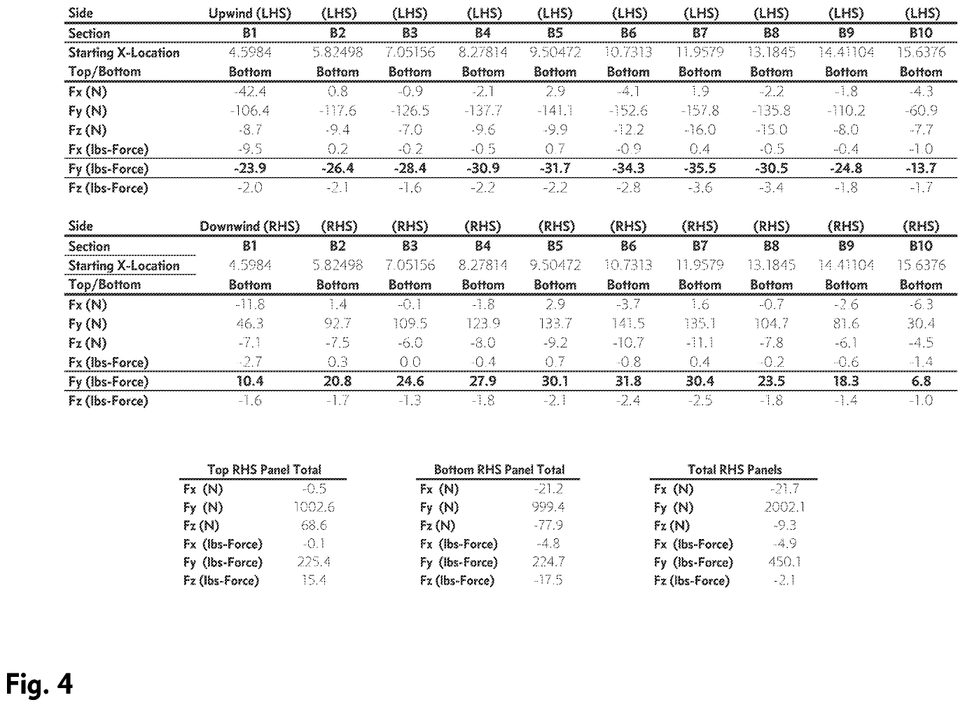

FIG. 4 shows a table of the CFD results from Auto Research Center.

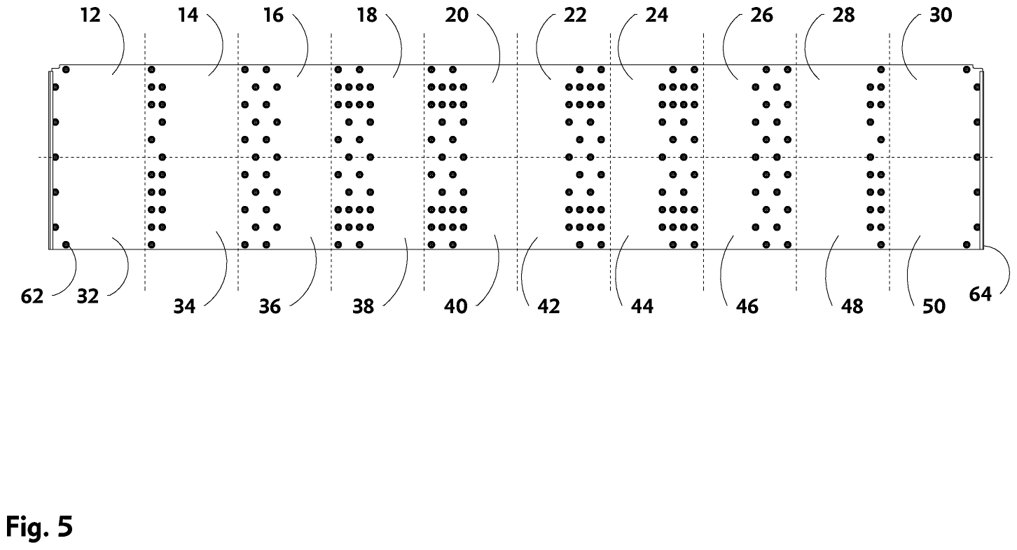

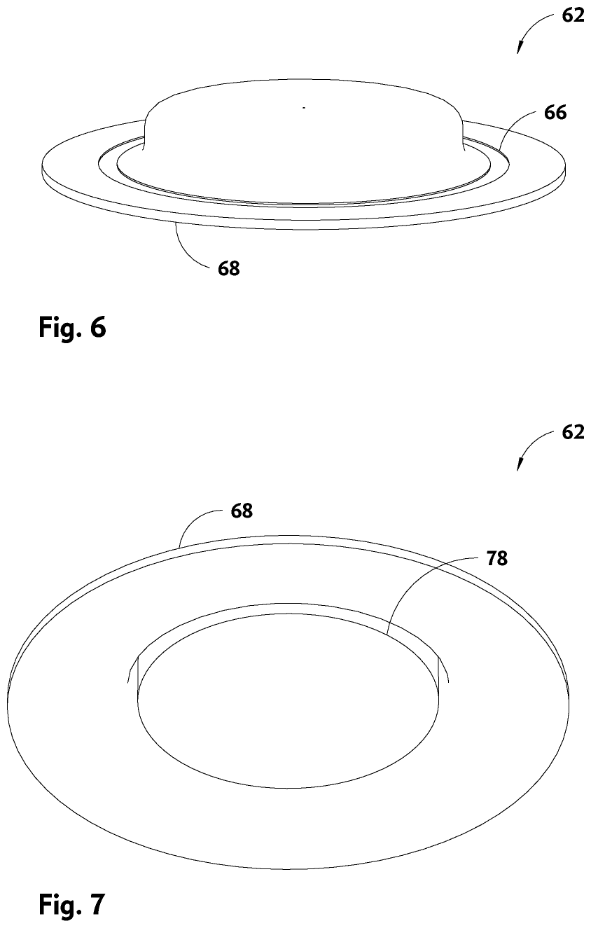

FIG. 5 shows a view of a pliable membrane and how to arrange magnet anchors according to FIGS. 3 and 4.

To make this apparatus, place magnets in each section labeled T1 12, etc. per the strength indicated in the respective Fig. Because the flute arrangement is not called out in the specification ISO 668-Series 1 Freight Containers, I recommend adding several vertical rows of magnets to ensure that the pliable membrane will adhere to a minimum number of flutes.

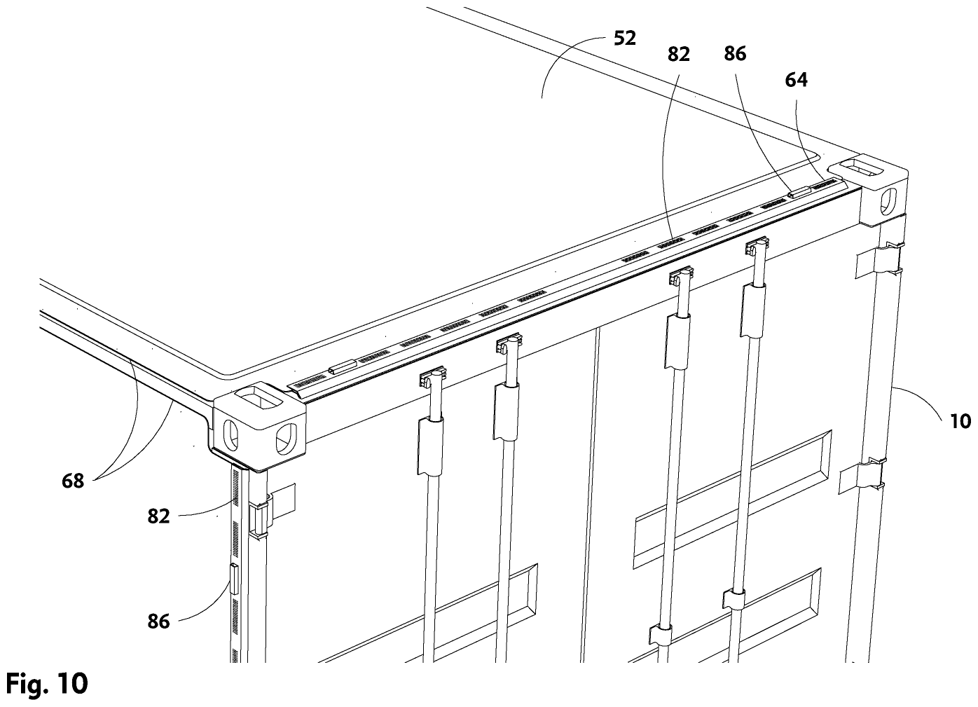

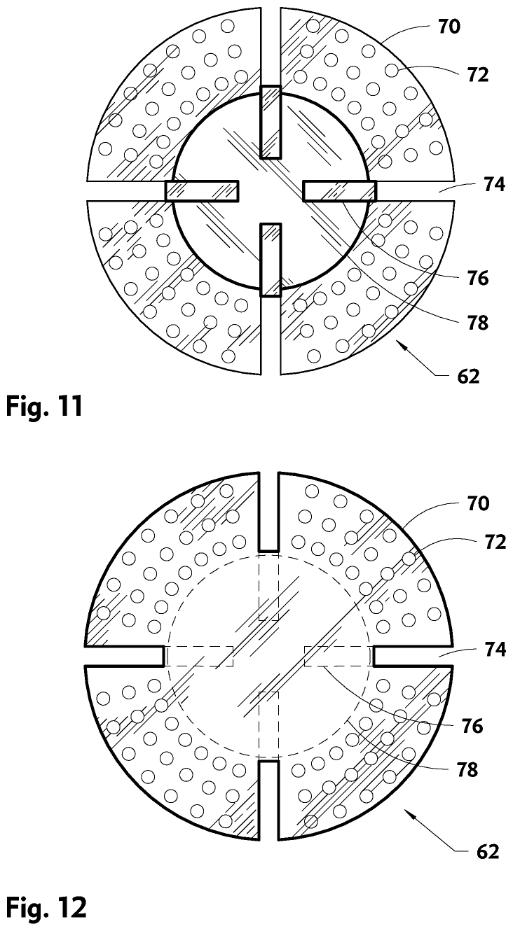

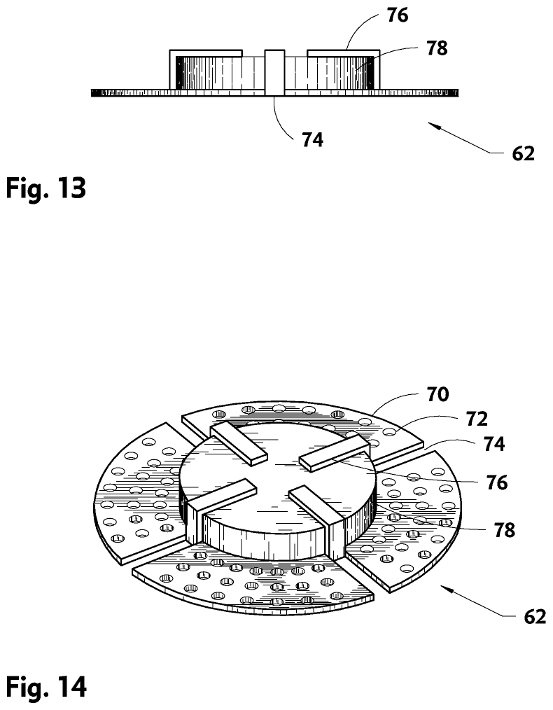

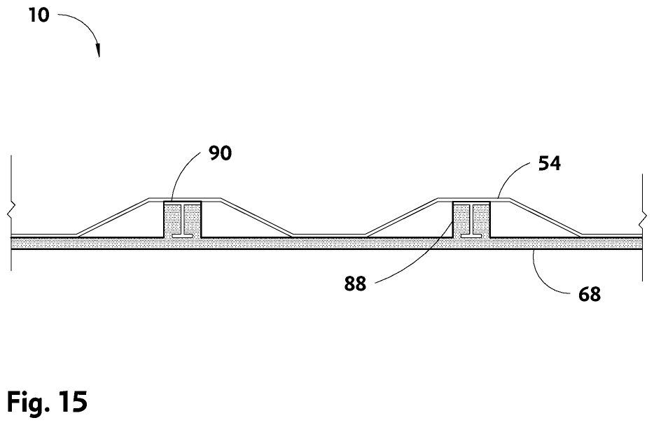

At the sides of the membrane, wind seals 62 are shown. These are presently thought to use bent sheet metal with punches holes for threading a thread, or the punched holes themselves lock the edge of the membrane. See FIG. 10 for more information.

Certainly, if you calculated the pulling forces needed for the center sections T5 20 and B5 and used a completely magnetized pliable membrane with suitable load resistance capability, it is possible that no magnet anchors are required. You could simply use a magnetized pliable membrane. This embodiment, while useful, comes at a higher price than that shown in this Fig.

FIG. 6 shows an upper perspective view of a magnet anchor formed from a piece of pliable membrane 68 which is heat welded. A heat weld 66 is shown sandwiching a magnet which will be shown in the following Fig.

FIG. 7 shows a lower perspective view of magnet anchor formed from a piece of pliable membrane 68 which is heat welded. A magnet 68 is shown. The heat weld will be applied to the main pliable membrane which covers a side of a series 1 freight container.

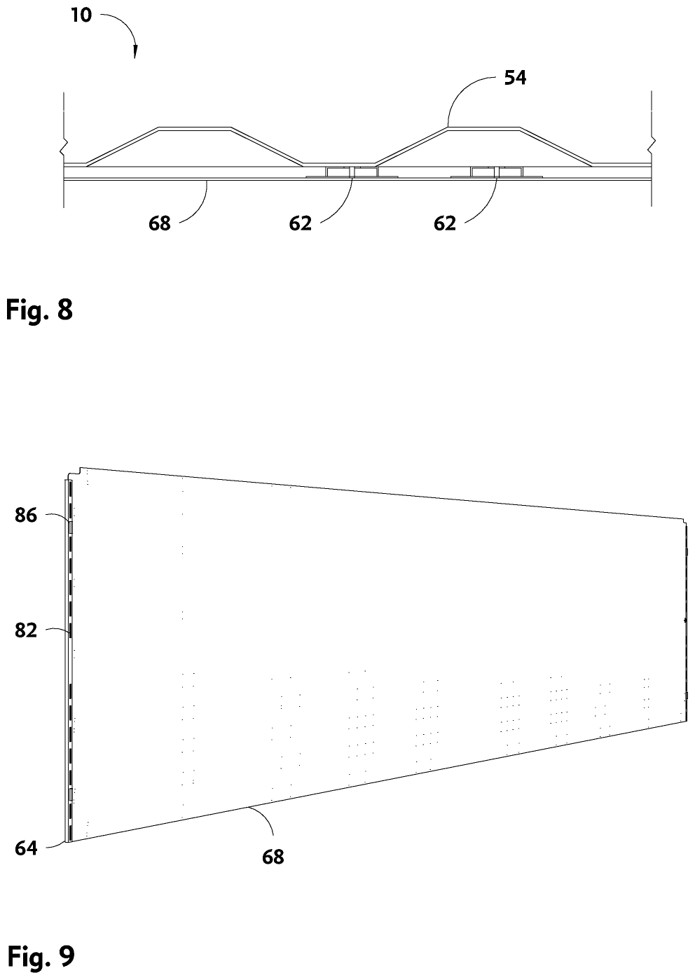

FIG. 8 illustrates a plan view of how magnet anchors 62 adhere to a steel flute 54. Several vertical rows of magnets can prevent the unfortunate situation where no magnet 320 anchors 62 align with a steel flute 54.

While the overall size of the pliable membrane 68 can be counted upon, as the overall shape of a series 1 freight container is prescribed in ISO 668, the flutes are not.

FIG. 9 shows a perspective view of a pliable membrane 68 with wind seals 64 attached.

Punched spooling slots 86 enable a spooling machine to lock into the slot with rods and begin rolling the pliable membrane 68 for application and removal purposes.

Keeping a pliable membrane 68 attached to a series 1 freight container 10 during transit has other advantages. The pliable membrane 68 provides a surface on which to place advertisements. As we have seen above, magnets must be placed at various quantities and strengths, in specific areas, along a side of series 1 freight container 10.

Not only will this apparatus save money on fuel, but it will also earn money for the truck driving professionals who use the pliable membrane. One last thought is that a GPS tracker may be added to the pliable membrane so that the advertisers may have a printout of where their advertisements were shown.

FIG. 10 shows a low aerial perspective view of the top side 52 of a skinned series 1 freight container 10. Pliable membranes 68 are shown on both the side and top of the container.

### DESCRIPTION OF EMBODIMENTS

FIG. 11 shows a top plan view of magnet anchor 62 punched from a metal plate 70. While there is nothing special about the circle as a shape for a magnet anchor 62, I do think that not having corners, or at least sharp corners, is practical.

In this example, a circular metal plate 70 is punched with a series of holes 72 forming a circle. Likely, in the same punch four bent tabs 76 are formed. A magnet 78 is placed at the center of the bent tabs 76 where the final process of bending the remaining portion of tab around the magnet.

The holes 72 may be threaded with twine or another commercial grade thread to the pliable membrane 68.

FIG. 12 shows a bottom plan view of a magnet anchor 62 substantially similar to FIG. 11 other than you may see the back side of the anchor. It is clear here that the bent tabs 76 prevent the magnet anchor 62 from being released.

FIG. 13 shows an elevation view of the magnet anchor 62 of FIG. 11.

FIG. 14 shows a perspective view of a magnet anchor 62 of FIG. 11. Here the slot 74 is more clear. It simply is the void of the punched bent tab 76.

FIG. 15 shows a plan view of a pliable membrane with integrally formed protruding volumes of pliable membrane material which are sized, shaped, and placed to make contact with the valley of a steel flute.

There are a number of other options such as accordion panels with hinges that smooth out the flutes of a series 1 freight container 10. Some magnets could be wider than the ones shown here in these FIGS. In that manner, they will always make magnetic contact.

### REFERENCE SIGNS LIST (numbers are bolded in description)

10 series 1 freight container
12 T1 of FIG. 3
14 T2 of FIG. 3
16 T3 of FIG. 3
18 T4 of FIG. 3
T5 of FIG. 3
22 T6 of FIG. 3
24 T7 of FIG. 3
26 T8 of FIG. 3
28 T9 of FIG. 3
T10 of FIG. 3
32 B1 of FIG. 4
34 B2 of FIG. 4
36 B3 of FIG. 4
38 B4 of FIG. 4
B5 of FIG. 4
42 B6 of FIG. 4
44 B7 of FIG. 4
46 B8 of FIG. 4
48 B9 of FIG. 4
50 B10 of FIG. 4
52 top side (of series 1 freight container)
54 flutes
56 bottom framing (of series 1 freight container)
58 side wall (of series 1 freight container)
60 entrance end wall (of series 1 freight container)
62 magnet anchor
64 wind seal
66 heat weld
68 pliable membrane
70 metal plate
72 hole
74 slot

### REFERENCE SIGNS LIST-continued (numbers are bolded in description)

74 slot
76 bent tab
78 magnet
80 rigid sheet
82 punched holes
84 rigid panel
86 punched spooling slot
88 integrally formed protruding volumes
90 magnetic studs

### CLAIMS GLOSSARY

(Specific claim terms are in italics throughout this disclosure. These claim terms represent an overview; for a richer understanding of these consistent terms consult the description and drawings.)
magnet anchor A single piece of flat material with cut and bent tab(s) which permanently wrap a magnet. The magnet backing is used to create resistance in a pliable membrane to prevent the magnet from being separated from the membrane.
plurality Two or more
punched spooling A linear punched slot in a piece of sheet metal. The
slot(s) protruding slot provides a void for a spooling rod to enter and begin rolling a pliable membrane.
series 1 freight A freight container designed to the International container Organization for Standards ISO 668 specification.
skin (s, ned, ning) An article that smooths the gaps found in a steel flute.
   A state where it can be said a container has had a skin applied to it.
   The act to which an apparatus applies a pliable membrane to a side of a series one freight container.

### CITATION LIST

The following is a tabulation of some prior art that presently appears relevant.

U.S. Patents

| Patent Number | Kind Code | Issue Date | Patentee |
|---|---|---|---|
| U.S. Pat. No. 10,745,066 | B2 | 2020 Aug. 18 | Prakash et al. |
| U.S. Pat. No. 4,756,256 | | 1988 Jul. 12 | Rains et al. |
| U.S. Pat. No. 4,518,188 | | 1985 May 21 | Witten |
| U.S. Pat. No. 8,496,286 | B1 | 2013 Jul. 30 | Katz et al. |
| U.S. Pat. No. 3,372,503 | | 1968 Mar. 12 | Weeks |

U.S. Patent Application Publications

| Patent Number | Kind Code | Issue Date | Patentee |
|---|---|---|---|
| US 20090230725 | A1 | 2009 Sep. 17 | Juieng |
| US 2010/0116932 | A1 | 2010 May 13 | Helou, Jr. |
| US 2011/0181072 | A1 | 2011 Jul. 28 | Kempster |

Foreign Patent Documents

| Foreign Doc. Num. | Kind Code | Issue Date | App or Patentee |
|---|---|---|---|
| WO 2021/124175 | A1 | 2021 Jun. 24 | 3M Innovative Properties |
| | | | Company |

### Nonpatent Literature Documents

Levinson, Marc, The Box: How the Shipping Container Made the World Smaller and the World Economy Bigger, (Princeton, NJ), pp. 68,191.
Sidewall (40′ High Cube) CX44-Bundle| InSoFast Container Insulation. (n.d.). InSoFast. https://www.insofast.com/products/40-ft-shipping-container-insulation-9-ft-high-cube-sidewall-cx44-bundle.html
Brandon Hilliard Follow. (n.d.). An aerodynamic study of bulk commodity tractor trailers.
   Share and Discover Knowledge on SlideShare.
   https://www.slideshare.net/BrandonHilliard6/an-aerodynamic-study-of-bulk-commodity-tractor-trailers
Roeth, M. (2015 July 17). Miles to Go| Running Green content from Fleet Owner.
   web.archive.org.
   https://web.archive.org/web/20150726054227/http://fleetowner.com/running-green/miles-goNational Average Gas Prices. AAA Gas Prices. (n.d.). Retrieved Jul. 28, 2022, from https://gasprices.aaa.com/

I claim:

1. The combination of claim 21 wherein said pliable membrane has a plurality of integrally formed protruding volumes which are sized, shaped and adapted to make contact with the valleys of said series of flutes;
further, a plurality of magnetic studs are located within said plurality of integrally formed protruding volumes
wherein each said magnetic stud includes an enlarged end, a rod-like middle section, and a magnetic end having a magnetic resistance value;
wherein each said magnetic end is adapted to releasably connect with the respective valley of said series of flutes.

2. (canceled)

3. (canceled)

4. (canceled)

5. (canceled)

6. (canceled)

7. (canceled)

8. The combination of claim 20 further comprising a wind seal formed from a piece of sheet metal bent to sandwich an end of said pliable membrane.

9. The combination of claim 8(23), wherein said piece of sheet metal is further bent to create an angled crimp which bridges a gap between one of said plurality of exterior walls of said freight container and said pliable membrane, thereby creating an angled wind seal.

10. The combination of claim 8(23), wherein said piece of sheet metal includes a plurality of crimped holes that are punched through said pliable membrane, such that it is adapted to be permanently affixed thereto.

11. The combination of claim 8(23), wherein said piece of sheet metal includes a plurality of punched spooling slots, enabling a spooling rod to enter said plurality of punched spooling slots and roll said pliable membrane.

12. (canceled)

13. A method of applying a means for attachment having a pattern of negative pressure resistance values, to a sheet of material comprising the steps of:
3. measuring on a sheet of material sized, shaped and adapted to substantially cover a side of a freight container an equidistant series of 20 conceptual rectangles having a top row, a bottom row, and ten vertical columns,
a first portion of said equidistant series of 20 conceptual rectangles having labels T1 through T10 are located at said top row, in the leftmost to tenth-leftmost columns when viewing said said sheet of material in elevation view,
a second portion of said equidistant series of 20 conceptual rectangles having labels B1 through B10 are located at said bottom row, in the leftmost to tenth-leftmost columns when viewing said said sheet of material in elevation view;
4. attaching a plurality of means for attaching to said sheet of material forming a pattern accordingly:
said first portion of said equidistant series of 20 conceptual rectangles with labels T1 through T10 respectively receiving at least said single baseline negative pressure resistance value, out of a plurality of negative pressure resistance values in a third portion of said plurality of means for attaching;
said second portion of said equidistant series of 20 conceptual rectangles with labels B1 through B10 respectively receiving at least a said single baseline negative pressure resistance value, out of plurality of baseline negative pressure resistance values in a fourth portion of said plurality of means for attaching,

14. The method of applying a means for attachment sheet of material of claim 13 wherein said sheet of material is further comprised of sub sheets.

15. (canceled)

16. (canceled)

17. (canceled)

18. The combination of claim 24(14) wherein said sub-panels
are connected with hinges.

19. (canceled)

21. The combination of claim 37(12) wherein said sheet of material is
a pliable membrane sized, shaped and adapted to substantially cover an exterior side of a freight container, having a series of flutes with peaks and valleys formed therein.

21. The combination of claim 20 wherein said pliable membrane is used in combination with a freight container having a rectangular, three-dimensional shape with a plurality of exterior walls further having a series of flutes with peaks and valleys formed therein.

22. A pattern of negative pressure resistance values comprising:
an equidistant series of 20 conceptual rectangles having a top row, a bottom row, and ten vertical columns, wherein a first portion of said 20 conceptual rectangles have labels T1 through T10 are located at said top row, in the leftmost to tenth-leftmost columns;
a second portion of said equidistant series of 20 conceptual rectangles have labels B1 through B10 are located at said bottom row, in the leftmost to tenth-leftmost columns.

23. The combination of claim 37(12) wherein said sheet of material is a substantially flat panel having an exterior side and a freight container side sized, shaped and adapted to substantially cover an exterior side of a freight container having a series of flutes with peaks and valleys formed therein.

24. The combination of claim 23(13), wherein said substantially flat panel is further comprised of sub-panels.

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. The pattern of negative pressure resistance values of claim 22(10) where said first portion of said equidistant series of 20 conceptual rectangles with labels T1 through T10 respectively receive at least a single negative pressure resistance value, out of a plurality of baseline negative pressure resistance values, of about:
T1=10.4 pounds,
T2=17.4 pounds,
T3=27.4 pounds,
T4=30.2 pounds,
T5=31.1 pounds,
T6=31.3 pounds,
T7=30.3 pounds,
T8=27.6 pounds,
T9=23.3 pounds,
T10=11.6 pounds,
where said second portion of said equidistant series of 20 conceptual rectangles with labels B1 through B10 respectively receiving at least a single baseline negative pressure resistance value, out of said plurality of baseline negative pressure resistance values, of about:
B1=10.4 pounds,
B2=20.8 pounds,
B3=24.6 pounds,
B4=27.9 pounds,
B5=30.1 pounds,
B6=31.8 pounds,
B7=30.4 pounds,
B8=23.5 pounds,
B9=18.3 pounds,
B10=6.8 pounds.

37. The pattern of negative pressure resistance values of claim 36(11) in combination with a sheet of material.

38. The combination of claim 37(12) further in combination with a means for resisting said negative pressure resistance values in such a way that enables said sheet of material to remain affixed to a wall of a freight container while in transit.

39. The combination of claim 38(16) wherein said means for resisting are fasteners.

40. The combination of claim 38(16) wherein said means for resisting are welds.

41. The combination of claim 38(16) wherein said means for resisting is magnetic.

42. The combination of claim 38(16) wherein said means for resisting are a plurality of magnet anchors.

43. An improved freight container comprising:
a freight container having corner castings, and a plurality of walls having a series of flutes with peaks and valleys formed therein;
at least one of the walls having a substantially flat sheet of material structurally attached thereto, the sheet of material stays flat during transit and is sized, shaped and adapted to substantially cover the at least one wall, said sheet of material is proud of the flutes and does not project beyond the perimeter of the corner castings;
further, said sheet of material does not snag when lowering into a ship's hold;
further still, said sheet of material does not touch other freight containers when stacking above, below, and adjacently.

44. The freight container of claim 43 wherein a plurality of the walls each have a second substantially flat sheet of material similar to said substantially flat panel.

45. The freight container of claim 43 wherein said substantially flat sheet of material is further comprised of sub-sheets.

46. The freight container of claim 43 in combination with a spreader.

47. The freight container of claim 43 in combination with an intermodal chassis.

48. The freight container of claim 43 in combination with a cargo ship.

49. The freight container of claim 43 in combination with a freight well car.

50. A magnet anchor comprising an anchor backing having a plurality of holes.

51. The magnet anchor of claim 50 further comprising a plurality of bent tabs in said anchor backing.
